(19) United States
(12) Patent Application Publication
(10) Pub. No.: US 2025/0153368 A1
(43) Pub. Date: May 15, 2025

(54) Tire handling apparatus

(71) Applicant: MECHANIZE PTY LTD, Middle Ridge (AU)

(72) Inventor: Brett Michael Salomon, Red Hill (AU)

(21) Appl. No.: 18/943,300

(22) Filed: Nov. 11, 2024

(30) Foreign Application Priority Data
Nov. 10, 2023 (AU) 2023903617

(51) Int. Cl. B25J 15/00

(52) U.S. Cl. CPC B25J 15/0033

(57) ABSTRACT

A tire handling apparatus adapted to grip, lift and move a tire in one or more directions, the apparatus comprising: an attachment frame configured for attachment to a forklift or a front end loader, the attachment frame being movably disposed when attached to said forklift or front end loader; a tire handling frame supported on said attachment frame, the tire handling frame comprising: two spaced apart articulated arms, each arm having proximal and distal arm portions whereby the proximal arm portion is proximately coupled to the attachment frame, said proximal and distal arm portions being arranged to effect sideways movement of the distal arm portions towards and away from each other; wherein each of said distal arm portions is attached to a respective tire retaining sub-assembly comprising an upper retainer that is vertically spaced apart from a lower retainer.

### FIELD OF THE INVENTION

The present invention relates to apparatus for handling the tires of heavy vehicles, particularly the extremely large vehicles used in mining and similar industries.

### BACKGROUND OF THE INVENTION

Heavy vehicles' tire assemblies can have a diameter of several meters and may weigh several tonnes. As such, they require specialist machinery to lift, fit, secure, and remove from heavy vehicles, particularly those used in mining. Existing machinery can be cumbersome, slow to use, require several operators, and may pose a danger to said operators and the tires themselves.

To be fitted, a tire must be lifted from the storage location, relocated to be in proximity of the wheel (or axle, hub etc., depending on the specific situation), and placed in the appropriate orientation (typically such that the circumference is in line with a primarily vertical plane), have its centre aligned precisely with the centre of the wheel or axle of the relevant vehicle, and secured thereto. As such, a tire handling apparatus should be able to lift, translate, manipulate, and secure a heavy vehicle tire. Current tire handling apparatus can accomplish the task but often have a limited range of motion and maneuverability, leading to slow tire manipulation.

Known tire handling apparatus often suffer from visibility issues, requiring additional operators to ‘spot’ for the primary operator, and these additional operators often must be in a hazardous location relative to the tire. The need for communication between operators, often by hand signals, can slow the operation rate and potentially divert the primary operator's attention. A slowed tire replacement operation has an economic impact, reducing the time-in-use of the heavy vehicle. Diverted attention of the primary operator can increase the risk of accidents, which can be catastrophic if operators or bystanders are in the vicinity should control be lost.

A gripping force applied across opposing sides of the tire rim supports the tires during suspension and orientation in many commonly known apparatus. This gripping arrangement results in the tire not being positively secured when handling, relying on friction to remain suspended or correctly oriented. This is undesirable for a few reasons. If the applied gripping force is insufficient, the tire may fall from the device, posing a crushing hazard to operators nearby. If the gripping force is too tight, it can damage the material of the tire itself, forcing a potentially expensive and time-consuming replacement or in extreme cases causing the tire to deform catastrophically and dangerously. Further, a tire over-compressed during fitting may not be able to be easily inserted into position and secured to the wheel with the necessary jewellery (nuts, bolts etc.).

As such, it is desirable for there to be a tire handling apparatus that overcomes these deficits. In particular, an apparatus that provides sufficient visibility that a single operator is sufficient, that uses a positive securing mechanism to support the tire and thereby avoid the risks of over-and under-gripping the tire, and that has a sufficient range of motion to accomplish each stage of the tire changing operation in a time efficient manner.

### SUMMARY

According to a first aspect, there is provided a tire handling apparatus adapted to grip, lift and move a tire in one or more directions The apparatus comprises an attachment frame configured for attachment to a forklift or a front-end loader, the attachment frame being movably disposed when attached to said forklift or front-end loader. The apparatus further comprises a tire handling frame supported on said attachment frame, the tire handling frame comprising two spaced apart articulated arms, each arm having proximal and distal arm portions whereby the proximal arm portion is proximately coupled to the attachment frame, said proximal and distal arm portions being arranged to effect sideways movement of the distal arm portions towards and away from each other. Each of said distal arm portions is attached to a respective tire retaining sub-assembly comprising an upper retainer that is vertically spaced apart from a lower retainer.

In an embodiment, the proximal and distal arm portions are pivotally connected to each other to effect sideways movement of the distal arm portions towards and away from each other.

In an embodiment, each of said tire retaining sub-assembly comprises a tire retaining sub-frame attached to a corresponding distal arm whereby the upper and lower retainers in each tire retaining sub-assembly are movably disposed relative to the tire retaining sub-frame.

In an embodiment, an in-use upper section of the tire retaining sub-frame is attached to the corresponding distal arm.

In an embodiment, the upper and lower tire retainers in each of said respective tire retaining sub-assembly extend in a forwardly direction away from the tire retaining frame.

In an embodiment, each of the upper and lower tire retainers comprises an elongate configuration.

In an embodiment, each of the upper and lower tire retainers comprises a cylindrical configuration.

In an embodiment, each of the upper retainers is mounted to the upper section of the tire retaining sub frame by a mounting arrangement to allow movement of the upper retainer into and out of a vertical plane of the lower retainer and simultaneously raising or lowering the upper retainer relative to the lower retainer.

In an embodiment, the mounting arrangement comprises a mounting bracket with a first portion of the mounting bracket being fixedly coupled to an end of the upper retainer and a second portion of the mounting bracket being rotatably mounted to the upper section of the tire retaining sub-frame for effecting said movement of the upper retainer by allowing clockwise or anti-clockwise rotation of the mounting bracket relative to the tire retaining sub-frame.

In an embodiment, the tire handling apparatus further comprises an actuating arrangement for actuating said movement of the upper retainer.

In an embodiment, each of the upper and lower retainers is generally elongate and extends between a proximal end that is coupled to the tire retaining sub-frame and a distal end.

In an embodiment, the distal end of the upper and lower retainers comprises a rotatable stop member that is configured to rotate in a clockwise or anticlockwise direction to engage with side walls of a tire retained by the respective tire retaining sub-assemblies and prevent movement of the tire along the tire axis.

In an embodiment. movement of said articulated arms is effected by one or any combination of pneumatic or hydraulic cylinder, by electric or hydraulic motor or other actuation mechanisms.

In an embodiment, movement of the upper retainer is effected by any one or any combination of pneumatic or hydraulic cylinder, by electric or hydraulic motor or other actuation mechanisms.

In an embodiment the proximal arm portion for each articulating arm is pivotally mounted to the attachment frame.

In an embodiment, the attachment frame comprises a ring shaped configuration with an inner perimeter and an outer perimeter, wherein the inner perimeter defines a hollow volume that provides access therethrough for allowing one or more users to view a tire retained in the tire retaining sub-assembly and wherein the tire handling frame is attached to the portion of said attachment frame between the inner and outer perimeters.

In an embodiment, the tire retaining sub-assembly is pivotably attached to the articulated arm distal portion, wherein the tire retaining sub-assembly can rotate through a vertical plane largely perpendicular to the plane of the attachment frame.

In an embodiment, each of said tire retaining sub-assembly further comprises a push cylinder assembly arranged to apply a pushing force on a side wall of the tire retained in said tire retaining sub-assembly.

In an embodiment, the push cylinder assembly is located along a medial portion of the tire retaining sub-frame and wherein the push cylinder being movably attached to the medial portion of the tire retaining sub-frame.

### BRIEF DESCRIPTION OF FIGURES

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 depicts a tire handling apparatus in perspective view.

FIG. 2 depicts the tire handling apparatus of FIG. 1 in side view.

FIG. 3 depicts the tire handling apparatus of FIG. 1 in top view.

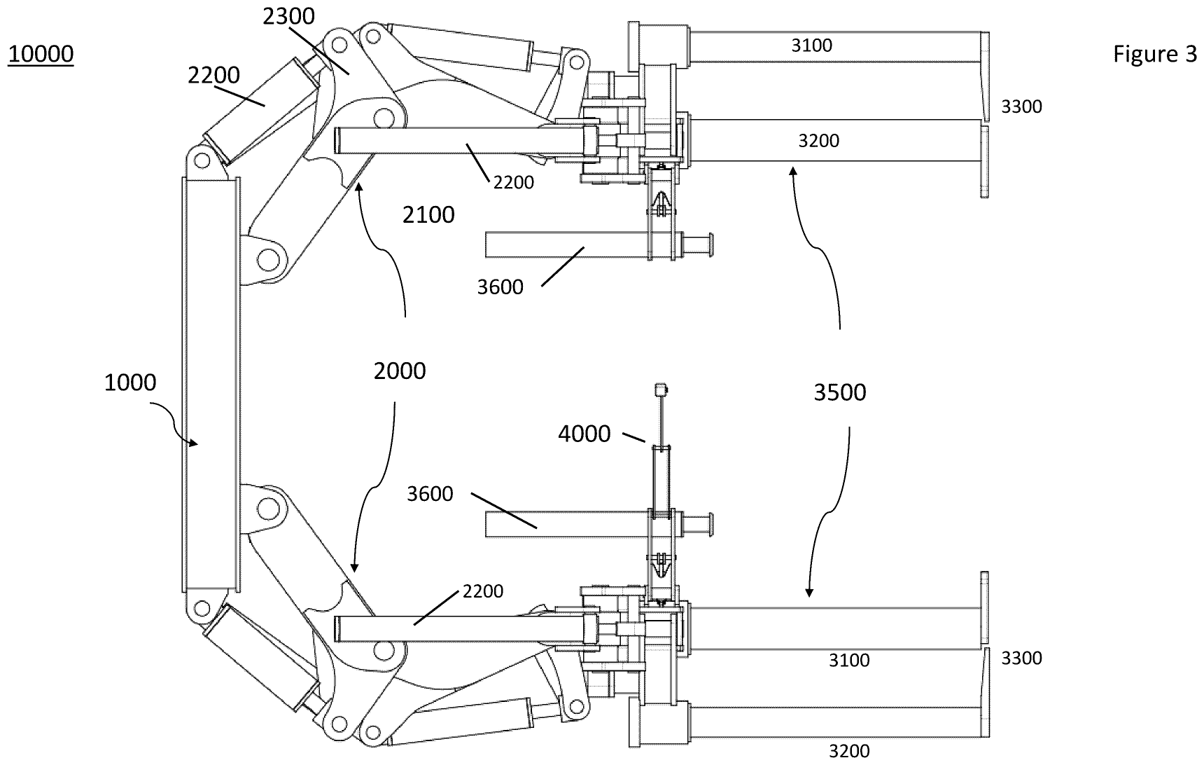

FIG. 4 depicts the tire handling apparatus of FIG. 1 in side view as attached to a forklift and with a tire loaded in a vertical orientation.

FIG. 5 depicts the tire handling apparatus of FIG. 1 in top view as attached to a forklift and with a tire loaded in a vertical orientation.

FIG. 6 depicts the tire handling apparatus of FIG. 1 in perspective view as attached to a forklift and with a tire loaded in a vertical orientation.

FIG. 7 depicts the tire handling apparatus of FIG. 1 in perspective view as attached to a forklift and with a tire loaded in a horizontal orientation.

FIG. 8 depicts a tire handling apparatus in perspective view as attached to a front-end loader and with a tire loaded in a vertical orientation.

FIG. 9 depicts a tire handling apparatus with an accompanying operator in a side perspective view.

FIG. 10 depicts the tire handling apparatus of FIG. 1 in perspective view with a clear line of sight through the hollow interior depicted.

### DETAILED DESCRIPTION

Reference will now be made in detail to the present preferred embodiments of the invention, examples of which are illustrated in the accompanying drawings.

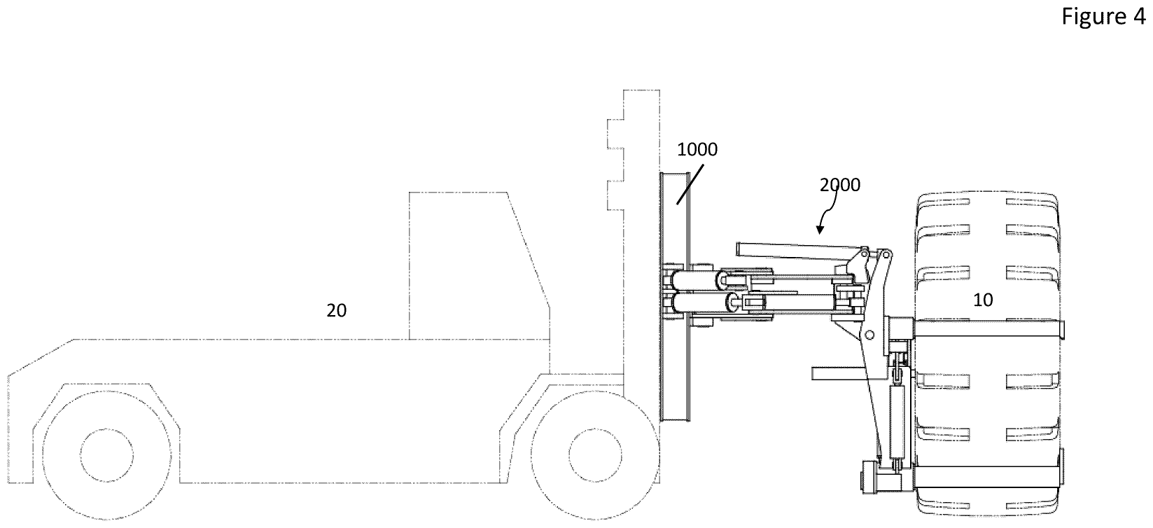

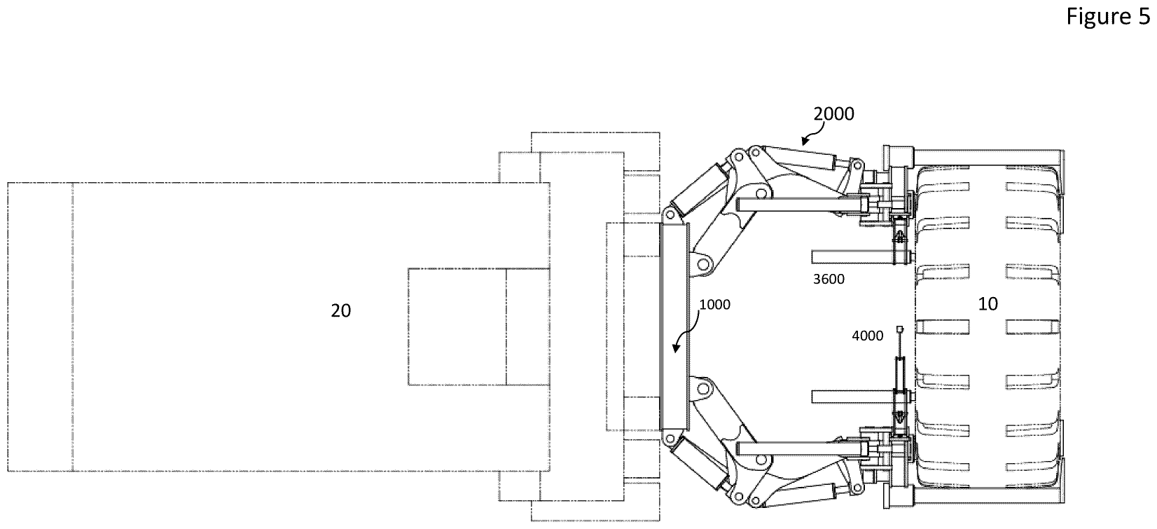

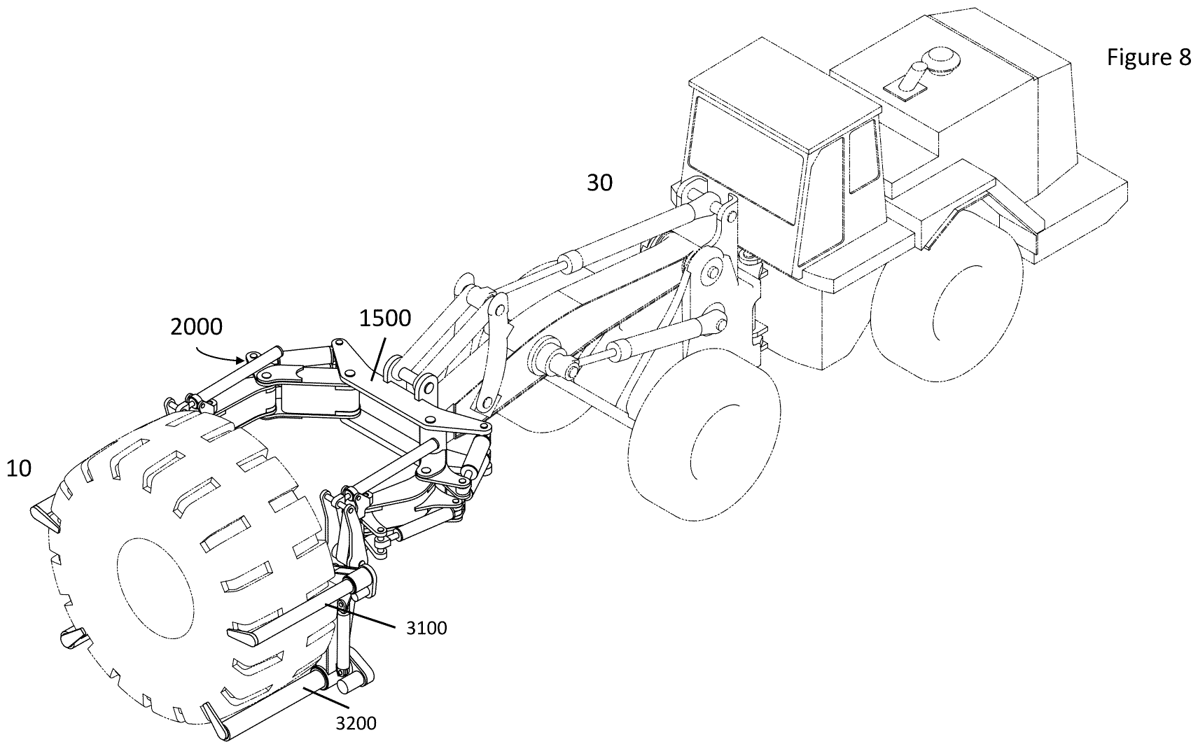

Shown is a preferred embodiment of a tire handling apparatus 10000. The tire handling apparatus 10000 consists of an attachment frame 1000 and a tire handling frame 2000. In the preferred embodiment, as seen in FIGS. 4-7, one side of the attachment frame 1000, called the proximal side, is attached to a vehicle such as a forklift 20 or another vehicle with an appropriate mounting location. In another embodiment, as seen in FIG. 8, this vehicle may be a front-end loader 30. It would be understood that any references to the working attachment frame 1000 throughout the specification is in no way limited to either a forklift or a front end loader.

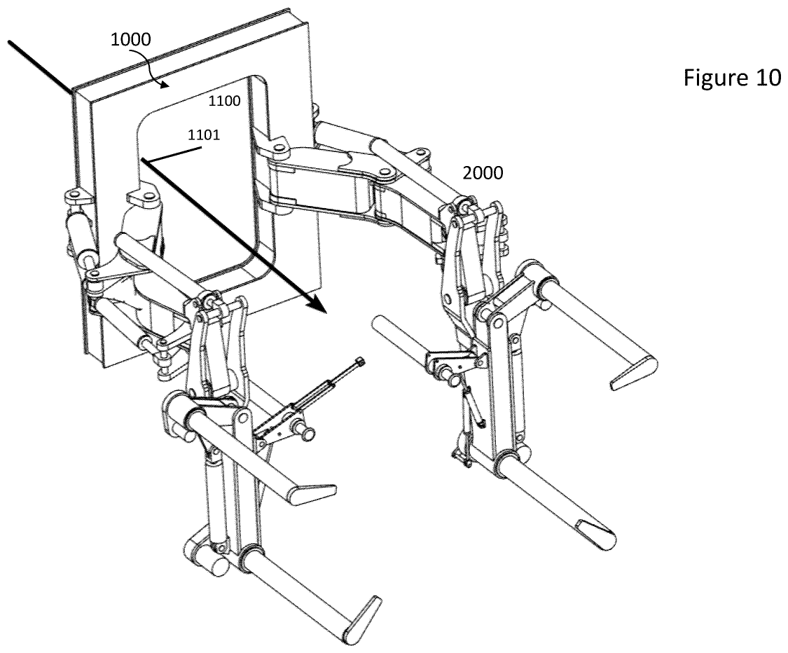

In the preferred embodiment, the attachment frame 1000 may take the form of a rectangular annulus in its most extensive, substantially vertical plane, such that an operator on one side of the attachment frame 1000 would have an unobstructed view 1101 of the other side through a hollow middle portion 1100 of said attachment frame 1000, as depicted in FIG. 10, forming a ring-like structure with a largely hollow opening that enables the unobstructed view 1101. The remaining solid portion of the attachment frame 1000 is made from an appropriate material, for example, steel and may be reinforced in ways known in the art. In the embodiment of FIG. 8, the attachment frame 1000′ takes a slightly different configuration (which is not ring-shaped) that is suitable for attachment to a front-end loader 30. In all embodiments, the tire handling frame 2000 is attached on the distal side of the attachment frame 1000 or 1000′. In further embodiments not illustrated herein, the tire handling frame 2000 may instead or also have attachment points on the lateral and medial sides of the attachment frame 1000. In the presently described embodiments, the tire handling frame 2000 is immovably attached to the attachment frame 1000 or 1000′. However, in other alternative embodiments, the tire handling frame 2000 may be movably attached to the attachment frame 1000 (or 1000′) such that the tire handling frame 2000 can translate or rotate along the distal surface of the attachment frame 1000 through a primarily vertical plane, thereby being raised or lowered. In the preferred embodiment such a movement mechanism is not necessary because the entire tire handling apparatus 10000 can be raised or lowered by the mechanism provided by the attached vehicle.

Returning to the preferred embodiment, the tire handling frame 2000 comprises two spaced apart articulated arms 2100. Each articulated arm 2100 is substantially identical to the other, save that they are mirrored about a central vertical plane (i.e., in the same way that the left and right human arms are the same but mirrored). Unless otherwise specified, it is assumed that a feature described for the right articulated arm 2100a is also present on the left articulated arm 2100b.

Each articulated arm 2100 can be subdivided into a proximal arm portion 2150 and a distal arm portion 2120. In the preferred embodiment, the proximal arm section 2150 is pivotally attached to the attachment frame 1000, so each articulated arm 2100 can pivot through a substantially horizontal plane, effecting sideways movement. In another embodiment, the proximal arm portion 2150 may be attached to the attachment frame 1000 fixedly, pivotally, or otherwise. In the preferred embodiment, the distal arm portion 2120 is pivotally attached to the distal end of the proximal arm portion 2150 so that the distal arm portion can also pivot through the substantially horizontal plane, thereby supplying a sideways arc of movement to the articulated arms 2100 and subsequently the tire retaining sub-assembly 3000. The ability for both the proximal 2150 and distal 2120 arm portions to pivot independently allows the tire handling apparatus 10000 to grip tires 10 of a range of sizes with the same degree of control. Further, this double articulation configuration provided by each articulated arm 2100 allows the tire handling apparatus 10000 to translate a tire 10 in a forward, substantially horizontal direction, even though the vehicle it is mounted upon remains stationary. The tire handling apparatus 10000 is capable of making fine adjustments in a finalized operating position for operations such as fixing a tire on a mining vehicle by effecting movement of the tire handling apparatus 10000 itself without the forward motion of the attached vehicle (forklift 20, front end loader 30, etc.).

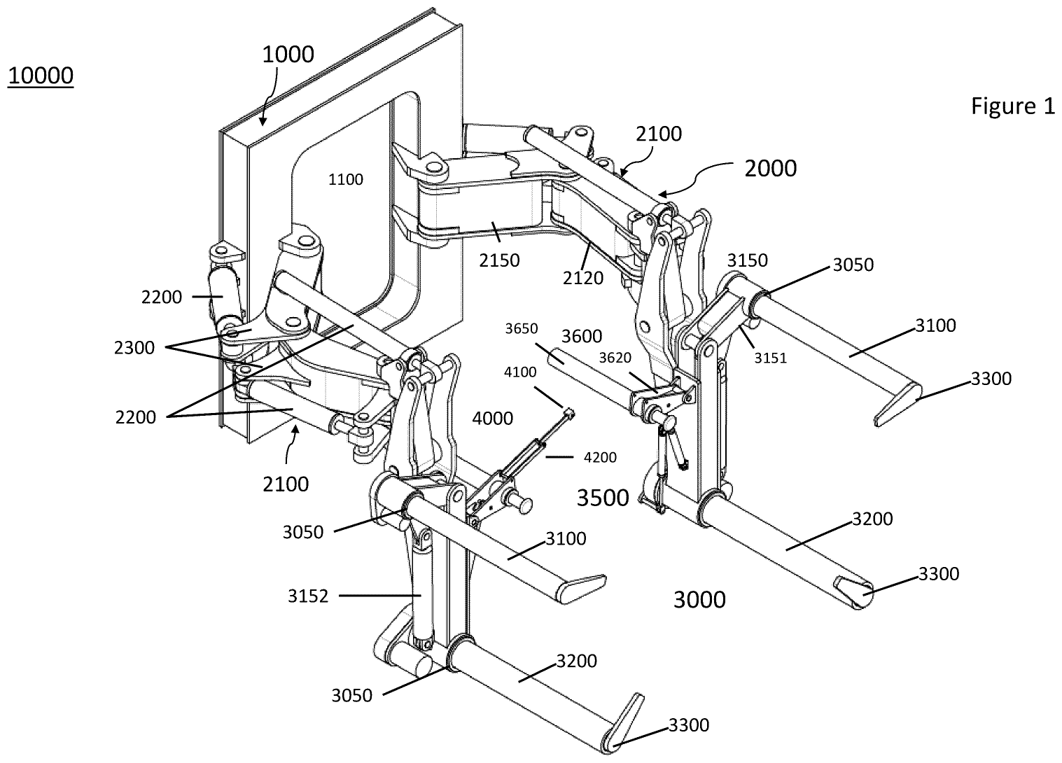

The movement of the articulated arms 2100 is effected by including one or more actuation mechanisms 2200. These actuation mechanisms may be pneumatic or hydraulic cylinders, electric motors, or any other mechanism capable of supplying the necessary movement to the articulated arms 2100. Sufficient actuation linkage points 2300 are provided to effect the necessary motion. For example, depicted in FIG. 1 is an embodiment utilising pneumatic or hydraulic cylinders. Actuation linkage points 2300 are provided at each end of the proximal 2150 and distal 2120 arm portions. These actuation linkage points 2300 are of appropriate orientation and scale to provide the necessary range and control of motion of the articulated arms 2100, as well known in the art.

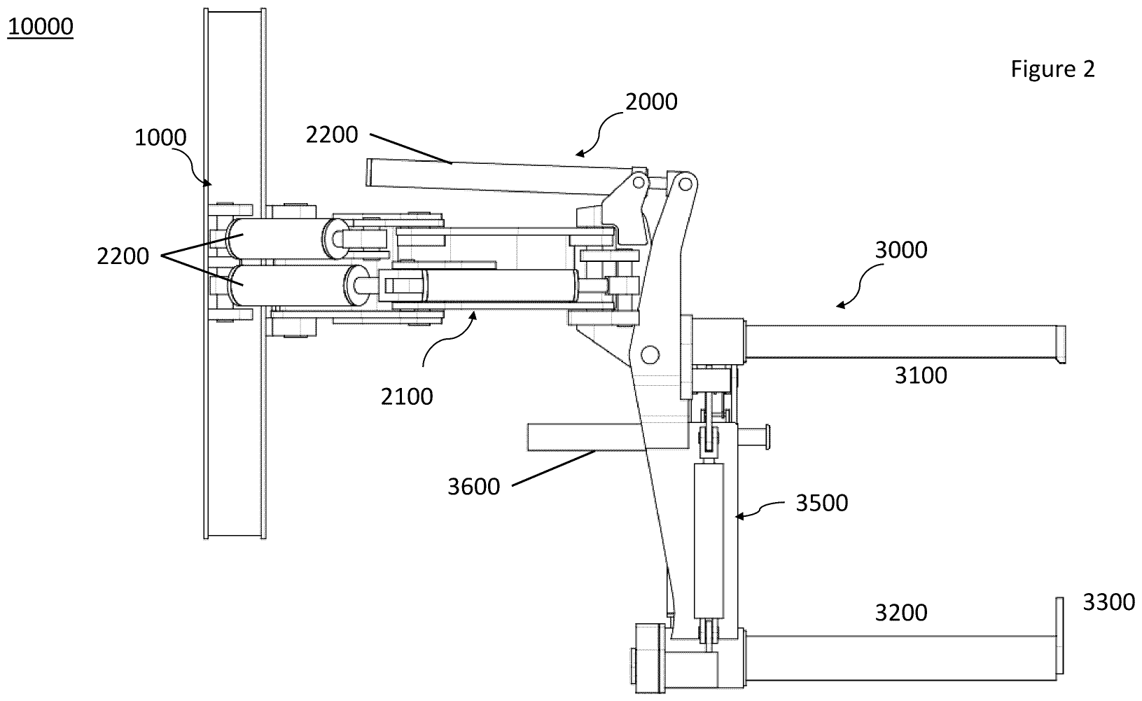

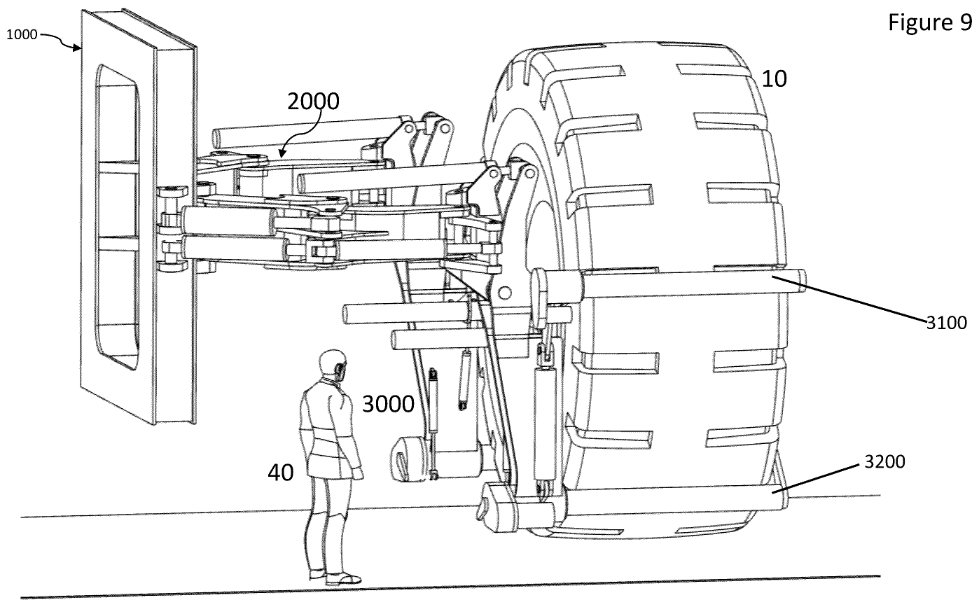

A tire retaining sub-assembly 3000 is attached to the distal end of the distal arm portion 2120. The tire retaining sub-assembly 3000 may be fixedly or pivotably attached to the distal arm portion. The tire retaining sub-assembly 3000 comprises a tire-retaining sub-frame 3500 which is attached to the distal arm portion 2120. The tire retaining sub-frame 3500 is attached to the distal arm portion 2120 toward the top end of the tire retaining sub-frame 3500, as shown in FIG. 2. This arrangement places the tire retaining sub-assembly 3000 substantially below the articulated arms 2100, and subsequently the handled tire 10 can be easily accessed while also maximising visibility and possible accessibility to the tire 10 for other operators 40 from below. This beneficial feature is shown in FIG. 9 in another embodiment, with like numerals referring to like features.

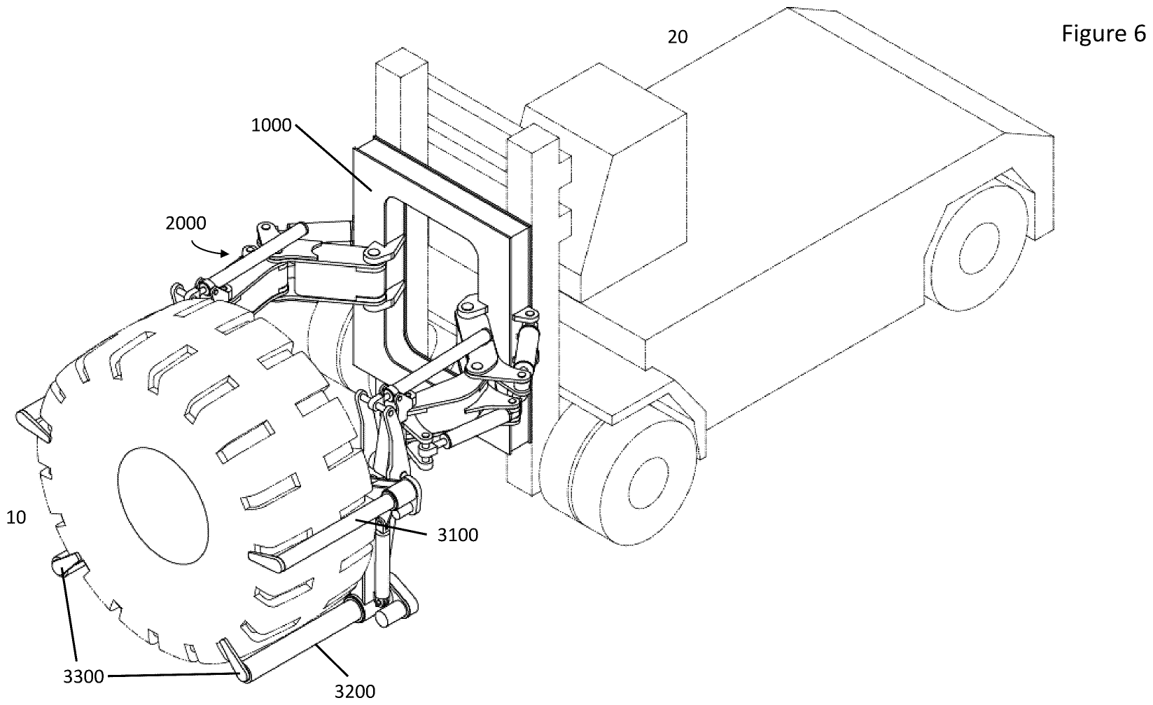

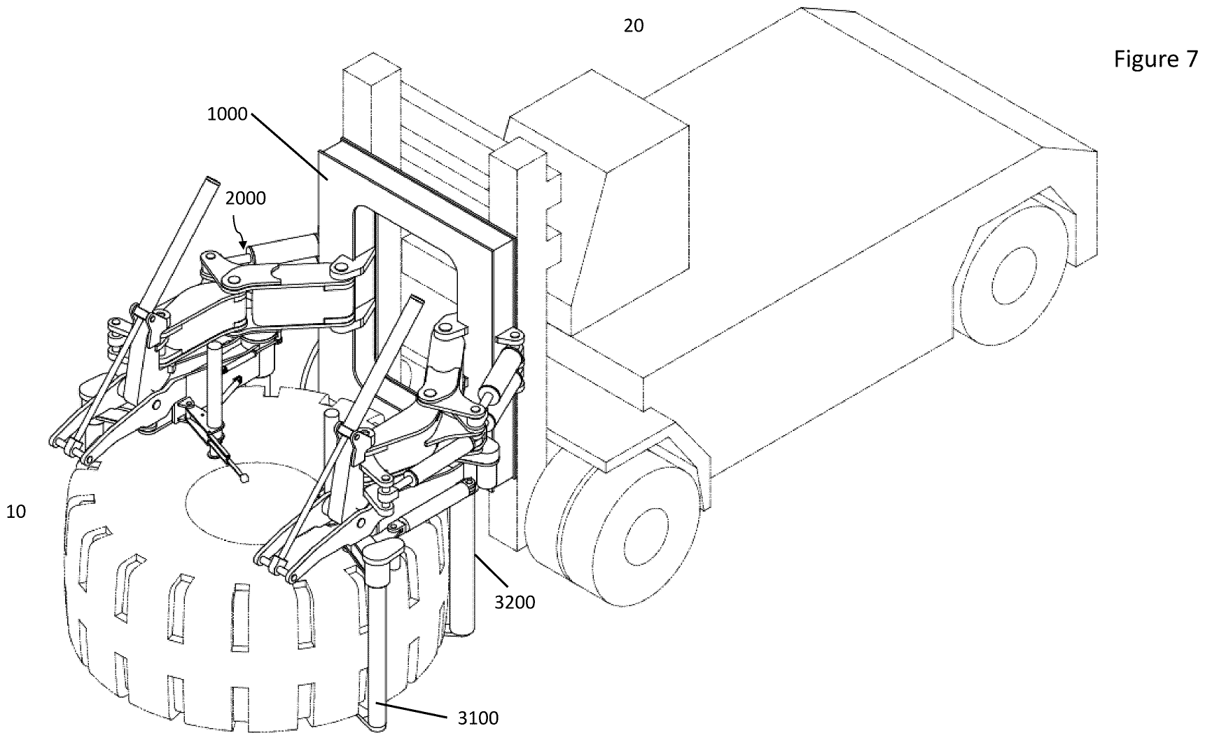

In a preferred embodiment, the tire retaining subassembly 3000 is pivotably attached such that the pivot action would cause said tire retaining sub-assembly 3000 to rotate between a substantially vertical orientation and a substantially horizontal orientation, as seen in the change from the orientation shown in FIG. 6 to that of FIG. 7. This rotation is effected by including one or more actuation mechanisms 2200. These may be pneumatic or hydraulic cylinders, electric motors, or any other mechanism capable of supplying the necessary movement. In the preferred embodiment, clearly seen in FIGS. 6 and 7, the actuation mechanism 2200 depicted is a pneumatic or hydraulic cylinder, pivotably attached at one secure point to the distal arm portion 2120 and at the other to an actuation linkage point 2300 of the tire handling sub-frame 3500. These actuation linkage points 2300 are of appropriate orientation and scale to provide the necessary range and control of motion of the tire retaining subassembly 3000, as well known in the art.

Attached to each tire retaining sub-frame 3500 are an upper retainer 3100 and lower retainer 3200 that are vertically spaced apart. Each of these upper and lower retainers 3100 and 3200 is substantially cylindrical and elongate, extending forward from the tire retaining sub-frame 3500. Each upper 3100 and lower 3200 retainer is housed in a retainer receiving portion 3050 of the tire retaining sub-frame 3500. Each of the upper and lower retainers 3100 and 3200 retainer can undergo rotational movement independently of the tire retaining sub-frame 3500 and of each other. The retainers rotate about the cylindrical long axis as rollers for a handled tire 10 for rolling the retained tire about the cylindrical long axis.

The upper retainer 3100 has an additional range of motion compared to the lower retainer 3200. While the lower retainer receiving portion 3050 is directly and fixedly attached to the tire retaining sub-frame 3500, the retainer receiving portion 3050 for the upper retainer 3100 is mounted to the tire retaining sub-frame by a mounting arrangement 3150. As well as the upper retainer receiving portion 3050, the mounting arrangement 3150 consists of a mounting bracket 3151 that is fixedly coupled to the retainer receiving portion 3050 at its lateral end and rotatably attached to the upper section of the tire retaining sub-frame at the other, medial end. The mounting arrangement 3150 further consists of an actuating arrangement 3152 that actuates the rotation of the mounting arrangement 3150 into and out of a vertical plane of the lower retainer 3200 and simultaneously raising or lowering the upper retainer 3100 relative to the lower retainer 3200. Providing the mounting arrangement 3150 allows tires of various diameters to be retained within the tire retaining sub-frames 3500 before undertaking tire handling for example by rotating the retained tire from a generally vertical orientation to a generally horizontal orientation.

At the distal end of each upper 3100 and lower 3200 retainer is a rotatable stop member 3300. These can rotate clockwise or anticlockwise such that upon completing an arc of rotation they may engage with the side walls of a handled tire 10 to prevent its forward motion, as seen in FIG. 6. Conversely, the rotatable stop members 3300 can rotate clockwise or anticlockwise to allow the forward motion of a handled tire 10, which is desirable at the completion of the tire handling operation. Further, when the tire retaining sub-assembly 3000 is tilted into a horizontal orientation, the rotatable stop members 3300 can be rotated to engage beneath a tire 10 which is oriented horizontally, as seen in FIG. 7. Thus, a tire 10 may be lifted into the vertical orientation when the tire retaining sub-assembly 3000 pivots from the horizontal orientation back to the vertical or any other orientation in between. In any orientation of tire retaining sub-assembly 3000, the rotatable stop members 3300 are sufficient to maintain the tire 10 in a position such that it does not move in a direction parallel to the upper 3100 and lower 3200 retainers, from the proximal end to toward the lateral ends thereof.

Located on the medial surface of the tire retaining sub-frame 3500 is a push cylinder assembly 3600. The push cylinder assembly 3600 consists of a push cylinder mounting bracket 3620, pivotably attached to the medial surface of the tire retaining sub-frame 3500 at its lateral end, with a push cylinder 3650 movably attached to the medial surface. When in position on the proximal side of a handled tire 10, the push cylinder is actuated to telescopically extend in the distal direction, thereby applying a pushing force to the side wall of the tire 10. This pushing force is sufficient to prevent backward, or proximal motion of the tire 10. An actuating mechanism 2200 of one of the types previously described provide motion to the push cylinder mounting bracket 3620 such that it will position the push cylinder 3650 into an operable position, no matter the scale of the tire 10 that is being handled.

In an embodiment, further operational visibility is provided by the inclusion of a camera apparatus 4000. This consists of a digital camera 4100 such as a small webcam, security camera, or similar, as would be known in the art, capable of sending useful visual information to an in-use screen visible to the operator. The digital camera 4100 is fixedly attached to the medial end of a mounting arm 4200, the lateral end of which may be attached to the medial end of a push cylinder mounting bracket 3620, or another suitable mounting location. The mounting arm 4200 may be extendible such that the digital camera 4100 can be moved between a stowed configuration and an in-use configuration, the in-use configuration being that wherein the visual field captured by the camera provides actionable information to the operator of the tire handling apparatus 10000. Extendibility of the mounting arm 4200 may be provided through a telescoping, folding, or other suitable mechanism as would be known in the art. In the preferred embodiment, the digital camera apparatus 4000 is featured on only one of the two tire retaining sub-frames 3500.

The aforementioned arrangement allows the tire handling apparatus 10000 to cradle the handled tire 10 as seen clearly in FIG. 6. The space between the articulated arms 2100 can widen or narrow to receive different sizes of tire 10. The lower retainer 3200 can be positioned beneath a vertically oriented tire 10 to support its weight. The mounting arrangement 3150 can rotate until the upper retainer 3100 is positioned above a handled tire 10 on either side, providing four contact points between the tire 10 and the upper 3100 and lower 3200 retainers. Further, the rotatable stop members 3300 and push cylinders 3650 provide sufficient stability that the tire does not fall forward or backward during operation, creating a fail-safe configuration. The combination of articulated arms 2100, various pivotable and rotation attachments, rotatable stop members 3300 and push cylinders 3650 means that a handled tire 10 can be controlled through the six rigid body degrees of freedom in a safe manner.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A tire handling apparatus adapted to grip, lift and move a tire in one or more directions, the apparatus comprising:
an attachment frame configured for attachment to a forklift or a front end loader or a prime mover, the attachment frame being movably disposed when attached to said forklift or front end loader;
a tire handling frame supported on said attachment frame, the tire handling frame comprising:
two spaced apart articulated arms, each arm having proximal and distal arm portions whereby the proximal arm portion is proximately coupled to the attachment frame, said proximal and distal arm portions being arranged to effect sideways movement of the distal arm portions towards and away from each other;
wherein each of said distal arm portions is attached to a respective tire retaining sub-assembly comprising an upper retainer that is vertically spaced apart from a lower retainer and wherein the upper and lower retainer are configured to simultaneously engage and retain a tire.

2. The tire handling apparatus in accordance with claim 1 wherein the proximal and distal arm portions are pivotally connected to each other to effect sideways movement of the distal arm portions towards and away from each other.

3. The tire handling apparatus in accordance with claim 1 wherein each of said tire retaining sub-assembly comprises a tire retaining sub-frame attached to a corresponding distal arm whereby the upper and lower retainers in each tire retaining sub-assembly are movably disposed relative to the tire retaining sub-frame.

4. The tire handling apparatus in accordance with claim 3 wherein an in-use upper section of the tire retaining sub-frame is attached to the corresponding distal arm.

5. The tire handling apparatus in accordance with claim 1 wherein the upper and lower tire retainers in each of said respective tire retaining sub-assembly extend in a forwardly direction away from the tire retaining frame.

6. The tire handling apparatus in accordance with claim 1 wherein each of the upper and lower tire retainers comprises an elongate configuration.

7. The tire handling apparatus in accordance with claim 1 wherein each of the upper and lower tire retainers comprises a cylindrical configuration.

8. The tire handling apparatus in accordance with claim 1 wherein each of the upper retainers is mounted to the upper section of the tire retaining sub-frame by a mounting arrangement to allow movement of the upper retainer into and out of a vertical plane of the lower retainer and simultaneously raising or lowering the upper retainer relative to the lower retainer.

9. The tire handling apparatus in accordance with claim 8 wherein the mounting arrangement comprises a mounting bracket with a first portion of the mounting bracket being fixedly coupled to an end of the upper retainer and a second portion of the mounting bracket being rotatably mounted to the upper section of the tire retaining sub-frame for effecting said movement of the upper retainer by allowing clockwise or anti-clockwise rotation of the mounting bracket relative to the tire retaining sub-frame.

10. The tire handling apparatus in accordance with claim 8 further comprising an actuating arrangement for actuating said movement of the upper retainer.

11. The tire handling apparatus in accordance with claim 1 wherein each of the upper and lower retainers is generally elongate and extends between a proximal end that is coupled to the tire retaining sub-frame and a distal end.

12. The tire handling apparatus in accordance with claim 11 wherein the distal end of the upper and lower retainers comprises a rotatable stop member that is configured to rotate in a clockwise or anticlockwise direction to engage with side walls of a tire retained by the respective tire retaining sub-assemblies and prevent movement of the tire in a forwardly direction along the tire axis.

13. The tire handling apparatus in accordance with claim 1 wherein movement of said articulated arms is effected by one or any combination of pneumatic or hydraulic cylinder, by electric or hydraulic motor or other actuation mechanisms.

14. The tire handling apparatus in accordance with claim 1 wherein movement of the upper retainer is effected by any one or any combination of pneumatic or hydraulic cylinder, by electric motor or other actuation mechanisms.

15. The tire handling apparatus in accordance with claim 1 wherein the proximal arm portion for each articulating arm is pivotally mounted to the attachment frame.

16. The tire handling apparatus in accordance with claim 1 wherein the attachment frame comprises a ring shaped configuration with an inner perimeter and an outer perimeter, wherein the inner perimeter defines a hollow volume that provides visibility therethrough for allowing one or more users to view a tire retained in the tire retaining sub-assembly and wherein the tire handling frame is attached to the portion of said attachment frame between the inner and outer perimeters.

17. The tire handling apparatus in accordance with claim 1 wherein the tire retaining sub-assembly is pivotably attached to the articulated arm distal portion, wherein the tire retaining sub-assembly can rotate through a vertical plane largely perpendicular to the plane of the attachment frame.

18. The tire handling apparatus in accordance with claim 3 wherein each of said tire retaining sub-assembly further comprises a push cylinder assembly arranged to apply a pushing force on a side wall of the tire retained in said tire retaining sub-assembly.

19. The tire handling apparatus in accordance with claim 18 wherein the push cylinder assembly is located along a medial portion of the tire retaining sub-frame and wherein the push cylinder being movably attached to the medial portion of the tire retaining sub-frame.
